(19) United States
(12) Patent Application Publication
(10) Pub. No.: US 2024/0229737 A1
(43) Pub. Date: Jul. 11, 2024

(54) FLUIDIC PROPULSION SYSTEM ENCLOSURE

(71) Applicant: Freedom Flight Works Inc., San Diego, CA (US)

(72) Inventors: Austin Blue, San Diego, CA (US); Scott Duffy, San Diego, CA (US)

(21) Appl. No.: 18/228,489

(22) Filed: Jul. 31, 2023

Related U.S. Application Data
(60) Provisional application No. 63/393,285, filed on Jul. 29, 2022.
(60) Provisional application No. 63/521,319, filed on Jun. 15, 2023.

(51) Int. Cl. F02K 1/44

(52) U.S. Cl. CPC F02K 1/44

(57) ABSTRACT

Fluidic propulsion system enclosures are described, including a high-pressure gas source container, a high-pressure gas source inlet, an ambient air inlet, a thruster container, a thruster outlet in fluid communication with the high-pressure gas source inlet and the ambient air inlet, and a housing substantially surrounding and interconnecting the high-pressure gas source container and the thruster container. The enclosure may include sound and/or energy abatement baffles within the housing, which may be arranged between the high-pressure gas source container and the thruster container.

Fluidic propulsion systems may be used on various types of aircraft, such as described in U.S. Pat. No. 10,207,812, entitled “FLUIDIC PROPULSION SYSTEM AND LIFT GENERATOR FOR AERIAL VEHICLES.” Such systems generally use a propulsor that entrains ambient air with a high-pressure gas, and directs the combined mixture of high-pressure gas and entrained ambient air over an airfoil to create lift. Jetoptera, Inc has developed a mature Fluidic Propulsion System™ (FPS™) that has many advantages for powered flight. Jetoptera's FPS™ is the result of more than five years of research and development, and since 2018 has been reduced to practical application. Jetoptera's FPS™ uses the Coanda effect which can be used to produce a high-speed, high-mass flow rate jet of air without the need for exposed blades or exposed machinery.

### BACKGROUND OF THE INVENTION

The present invention generally relates to an enclosure for a fluidic propulsion system.

Fluidic propulsion systems may use, for example, a gas turbine, turbo fan, or electrically powered compressor, etc., to provide the high-pressure gas used to entrain the ambient air.

The present subject matter provides certain benefits to fluidic propulsion systems, including reducing and/or directing noise created by the propulsion system. Aspects of the following disclosure may find applicability, for example, in various unconventional aviation applications, including Air-Ground Utility Vehicles such as those described in U.S. Pat. No. 9,682,620, entitled “AIR-GROUND VEHICLE WITH INTEGRATED FUEL TANK FRAME,” the contents of which are incorporated herein for all purposes.

### BRIEF SUMMARY OF THE INVENTION

According to first aspects of the disclosure, a fluidic propulsion system enclosure may include one or more of a high-pressure gas source container, a high-pressure gas source inlet, an ambient air inlet, a thruster container, a thruster outlet in fluid communication with the high-pressure gas source inlet and the ambient air inlet, and/or a housing substantially surrounding and interconnecting the high-pressure gas source container and the thruster container. In embodiments, the enclosure may include one or more sound and/or energy abatement baffles within the housing.

In embodiments, the top of the housing may be configured to be permanently, or selectively, open to the ambient air while the fluidic propulsion system is in operation.

In embodiments, the sound and/or energy abatement baffle(s) may be disposed between the high-pressure gas source container and the thruster container, and may include a sound and/or energy dampening material.

In embodiments, the housing may include a sound and/or energy dampening material.

In embodiments, the ambient air inlet may be disposed behind the high-pressure gas source container.

In embodiments, the enclosure may include the high-pressure gas source, such as gas turbine, a turbo fan, a compressor, or other mechanism.

In embodiments, the high-pressure gas source inlet may be configured to provide ambient air to the high-pressure gas source.

In embodiments, the high-pressure gas source may be entirely contained in the housing.

In embodiments, the enclosure may include the thruster. The thruster, when included, may be in fluid communication with the high-pressure gas source and the ambient air inlet. In embodiments, the thruster may be entirely contained in the housing.

In embodiments, the enclosure may include a fuel inlet.

In embodiments, the enclosure may include a fuel tank in fluid communication with the fuel inlet.

In embodiments, the enclosure may include a navigation system configured to calculate location, control exterior control surfaces and/or thruster orientation means, and/or process automated, semi-automated and/or manual navigation instructions.

According to further aspects of the disclosure, a fluidic propulsion system may be provided, including one or more of a high-pressure gas source, a high-pressure gas channel in fluid communication with the high-pressure gas source, an ambient air inlet, an ambient air channel in fluid communication with the ambient air inlet, a thruster in fluid communication with the high-pressure gas channel and the ambient air channel and configured to mix a high-pressure gas provided by the high-pressure gas source and a low-pressure gas provided by the ambient air inlet, a housing substantially surrounding the high-pressure gas source, the high-pressure gas channel, the ambient air channel, and the thruster, and/or a thruster outlet configured to eject the mixture of the high-pressure gas and the low-pressure gas as a combined gas flow.

In embodiments, the propulsion system may include one or more sound and/or energy abatement baffles within the housing. The sound and/or energy abatement baffle(s) may be disposed between the high-pressure gas source and the thruster.

In embodiments, the high-pressure gas source may be, for example, a gas turbine, a turbo fan, a compressor, or other mechanism.

According to yet further aspects of the disclosure, a powered airfoil may be provided including the fluidic propulsion system enclosure described herein. In embodiments, the powered airfoil may be, for example, a human-piloted ground vehicle with flight capability, or an autonomous or semi-autonomous unmanned aerial vehicle.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the related technology. No attempt is made to show structural details of technology in more detail than may be necessary for a fundamental understanding of the invention and various ways in which it may be practiced. In the drawings:

FIG. 1 depicts an exemplary “fully enclosed” fluidic propulsion system enclosure according to aspects of the disclosure.

FIG. 2 depicts an exemplary “fully enclosed” fluidic propulsion system enclosure, with the top cover removed, according to aspects of the disclosure.

FIG. 3 is a front isometric view of an exemplary fluidic propulsion system enclosure according to aspects of the disclosure.

FIG. 4 is a rear isometric view of an exemplary fluidic propulsion system enclosure according to aspects of the disclosure.

FIG. 5 depicts interior details of an exemplary fluidic propulsion system enclosure according to aspects of the disclosure.

FIG. 6 depicts components of an exemplary fluidic propulsion system, without an enclosure, according to aspects of the disclosure.

FIG. 7 depicts an exemplary implementation of a powered parafoil including a fluidic propulsion system with enclosure according to aspects of the disclosure.

FIG. 8 graphically depicts acoustic signature test results obtained, in part, from prototype fluidic propulsion systems and enclosures according to aspects of the disclosure.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a thruster” is a reference to one or more thrusters and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

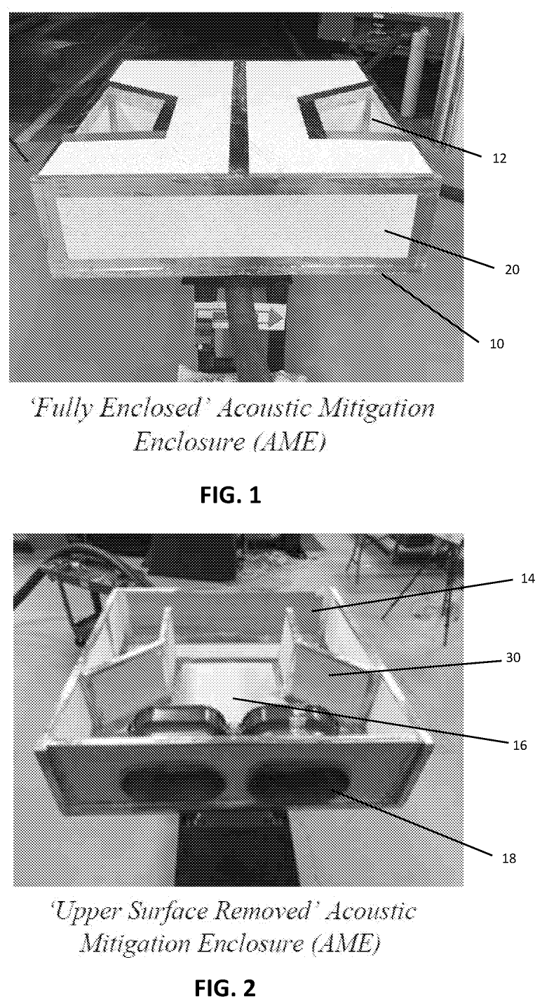

FIG. 1 shows a “fully enclosed” fluidic propulsion system enclosure 10 according to aspects of the disclosure. As used herein, “fully enclosed” should be understood as an enclosure that does not include separate high-pressure gas source and ambient air inlets. In this embodiment, holes 12 in the top surface of housing 20 are provided that enable air entrainment to the thrusters, and may provide ambient air to a high-pressure gas source as well.

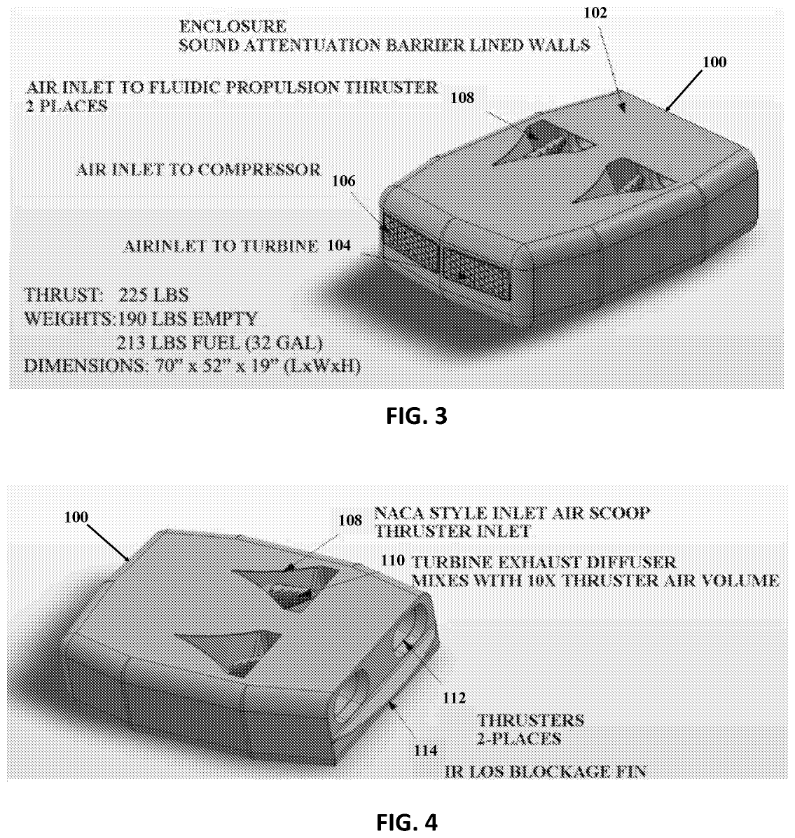

FIG. 2 shows the fluidic propulsion system enclosure 10 with the top cover of the housing 20 removed, and provides a view of the high-pressure gas source container 14, thruster container 16, and thruster outlets 18. In this regard, “containers” may be understood as portions of the housing, or other structures within the housing, that are configured to receive certain components of the fluidic propulsion system, such as the high-pressure gas source, thruster(s), etc.

The high-pressure gas source container 14 may be configured to house, for example, a gas turbine, a turbo fan, a compressor, or other mechanism that provides sufficient high-pressure gas to the fluidic propulsion thruster. Likewise, as described further below, the thruster container 16 may be configured to house various parts of the fluidic propulsion thruster including, for example, high-pressure gas conduits, control valves, nozzles, thruster orienting means, etc. The components and various designs of fluidic propulsion systems, in general, are known in the art, for example, as described in U.S. Pat. No. 10,501,197, entitled “FLUIDIC PROPULSIVE SYSTEM,” and are therefore not described in further detail than necessary.

FIG. 2 also shows exemplary baffles 30, which may be configured for several purposes within the enclosure 10, and other enclosures described herein. Baffles 30 may be provided in myriad configurations, and manufactured using various materials, and combinations of materials, in order to, for example, provide sound and/or energy abatement, assist with ambient air entrainment, etc. In the example shown in FIG. 2, the housing 20 and the baffles 30 were fabricated using a sandwich construction with inner and outer layers made from USG CGC R2310 RADAR acoustic ceiling tiles surrounding a layer of Home Depot TrafficMaster™ vinyl flooring tiles. This method of manufacture enabled a variable-density structure with sound absorption characteristics, described further below, at reasonable cost and ease of manufacture. However, designs using lighter-weight, precision materials, fabrication, and curved and/or more complex shapes, are also contemplated and fall within this disclosure.

FIG. 2 also shows exemplary thruster outlets 18, which may be configured to attach to one or more fluidic propulsion thrusters. As shown in FIG. 2, the thruster outlets 18 may extend slightly from the housing 20. However, in other embodiments, and unless otherwise specified, the thruster outlets may be recessed, substantially flush, or further extended from the housing 20, depending on the specific application.

The enclosure 10 is configured to substantially surround and interconnect the high-pressure gas source container 14 and the thruster container 16. As described further herein, “substantially surrounding” may allow for various air/gas intakes, exhausts, thruster outlets, fuel intakes, and/or other uncovered surface portions of the enclosure, in some embodiments.

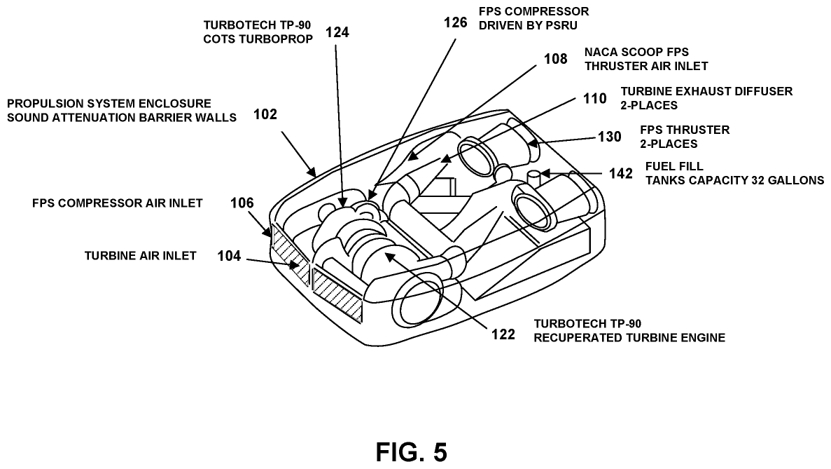

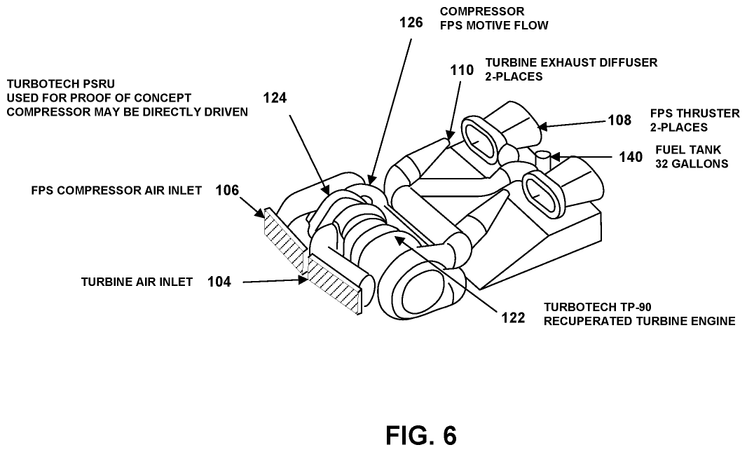

FIG. 3 is a front isometric view of an exemplary fluidic propulsion system enclosure 100 according to further aspects of the disclosure. FIG. 4 is a rear isometric view of fluidic propulsion system enclosure 100. As shown in FIG. 3, the fluidic propulsion system enclosure 100 includes a housing 102, a turbine inlet 104, a compressor inlet 106, and thruster intakes 108. FIG. 4 additionally shows a turbine exhaust diffuser 100 disposed generally in the thruster intake 108, thruster outlets 112, and a blocking fin 114 designed to reduce thermal signature by partially blocking line of sight from the ground to heated exhaust components.

As described further below, the turbine inlet 104 may be in fluid communication with a turbine engine, which is used to drive a compressor that is in fluid communication with compressor inlet 106. Thruster intakes 108 may be in fluid communication with a fluidic propulsion thruster, e.g. via ambient air vents, conduits, and/or open space within the enclosure 100. As with the enclosure 10 described above, the enclosure 100 may also be manufactured to include a sound dampening and/or energy absorbing structural, lining, and/or coating materials.

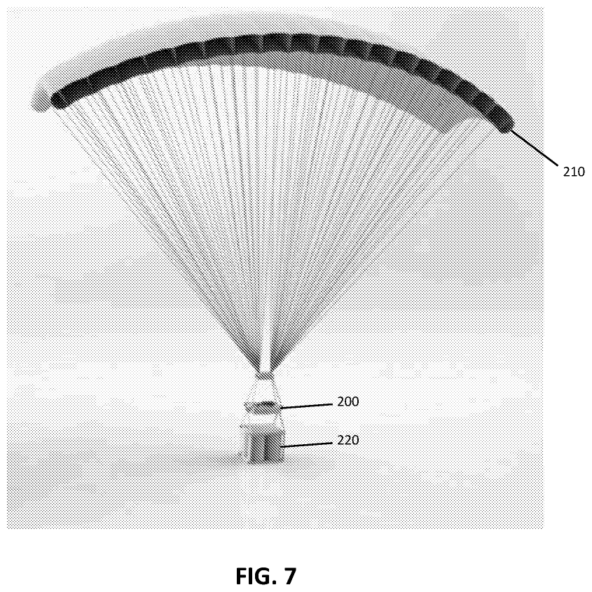

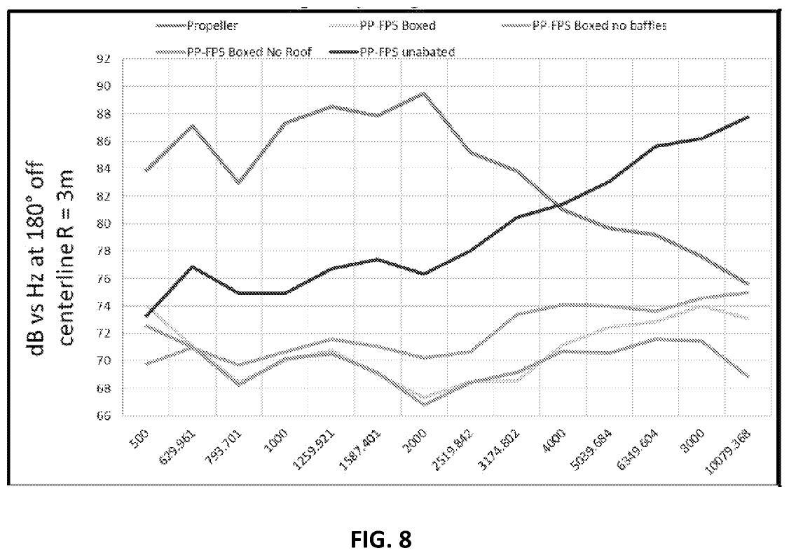

FIG. 5 depicts interior details of a fluidic propulsion system and enclosure 100, some of which are shown with the housing removed in FIG. 6. As shown in FIG. 5, the enclosure 100 may surround a high-pressure gas source including turbine engine 122, turboprop 124 and compressor 126. The enclosure 100 may also surround thrusters 130, which are in fluid communication with the compressor 126 (via high-pressure gas conduits), and with the thruster intakes 108 (which provide ambient air to the thrusters 130).

Turbine engine 122 receives ambient air via air inlet 104, and expels exhaust gas via the diffusers 110, disposed generally in the thruster intakes 108. Diffusers 110 may advantageously reduce the thermal signature of the fluidic propulsion system and enclosure 100 in operation. Compressor 126 receives ambient air via air inlet 106, and expels compressed high-pressure gas to thrusters 130, where the flow of high-pressure gas entrains ambient air (and exhaust gas) received via the air inlets 108. The mixture of the high-pressure gas and the entrained ambient air is ejected from thruster outlets 112 as a combined gas flow.

FIGS. 5 and 6 also show an exemplary fuel tank 140, which may contain fuel for the turbine engine 122, and a fuel fill opening 142, which may be provided on the exterior of the enclosure 100. Thus, the fluidic propulsion system and enclosure 100 shown in FIGS. 5 and 6 may be configured as an essentially “stand alone” unit, including the power source, the necessary fuel, and the thruster. Overall dimensions of such compact enclosures may be, for example, approximately 4′×4′×12″, or less. Dimensions and numbers of units will be variable based on cargo payloads, etc. For example, when attaching a parafoil to a 40′ shipping container, two larger-scale PP-FPS boxes may be used.

In embodiments, the enclosure 100 may include various other components (not shown), which may even further enhance the independent capabilities of the fluidic propulsion system and enclosure 100. For example, various navigation systems known in the art may be included to allow autonomous, semi-autonomous and/or manual control of the fluidic propulsion system and enclosure 100 when attached to or incorporated in a powered airfoil. For instance, JPADS may include a separate aircraft guidance unit (AGU) used for navigation. Additionally, the enclosure 100 may include exterior control surfaces and/or thruster orienting means configured to provide directional control of the enclosure 100 in flight.

Compared to the embodiment shown in FIGS. 1 and 2, the embodiment of FIGS. 3-6 includes a number of refined acoustic signature reducing features, including: noise source isolation and redirection, airflow optimization, and energy absorbing materials. Attention was also paid to enable a design with an extremely low thermal signature and that could also reduce radar signature. The resulting system is compatible with the existing JPADS 2000 hardware and scalable to meet a variety of cargo volumes and parachute sizes as well as different powered parafoil vehicle configurations.

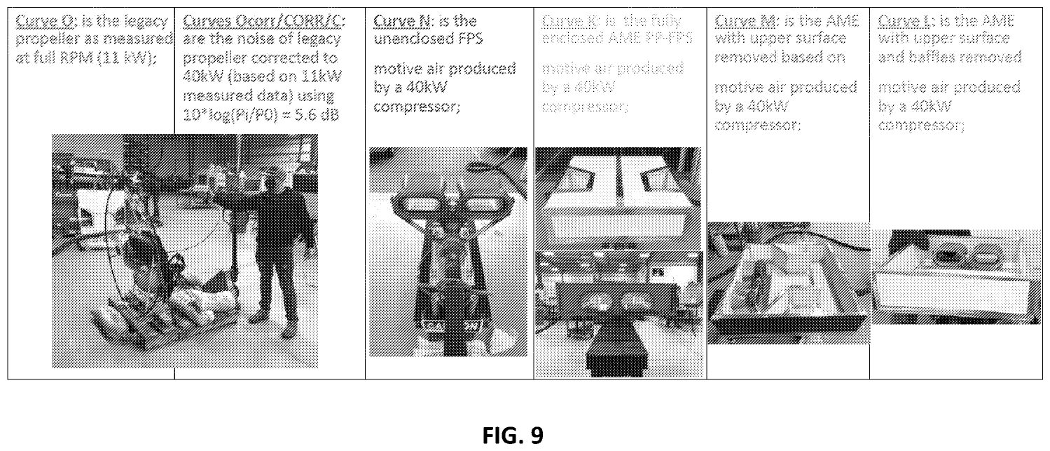

FIG. 7 depicts an exemplary implementation of a powered parafoil including a fluidic propulsion system with enclosure according to aspects of the disclosure. Specifically, FIG. 7 depicts a Joint Precision Airdrop System (JPADS) including a fluidic propulsion system with enclosure 200 (which may be similar to that shown and described in FIGS. 3 and 4). In such a system, the thrust is provided by the fluidic propulsion system and the lift is provided by the parafoil 210. In terms of scale, a fluidic propulsion system with enclosure 200 may be designed, for example, within a 44″×44″ square, with a height of approximately 10″, allowing it to be readily stacked on existing JPADS cargo stacks. Accordingly, cargo 220 can be transported significant distances, with precise autonomous (or semi-autonomous) navigation. Similar systems may be incorporated in a Long Range Precision Aerial Delivery System (LRPADS) having operational ranges in excess of 300 miles.

A sound and/or energy dampened JPADS such as shown in FIG. 7 provides myriad advantages over known systems, particularly on the modern battlefield, where threats to relatively-slow airborne assets are ever-increasing. For example, currently-available powered parafoils almost always operate using normally aspirated gasoline fueled engines driving a propeller. Those configurations have the advantage of being low cost, but also produce a significant amount of noise and heat, making them identifiable to observers on the ground. Propulsion system and enclosure improvements described herein have been found to provide reductions in acoustic and/or thermal signatures, significantly mitigating enemy identification and tracking of powered parafoils.

As but one example, the inventors have found that the combination of features related to fluidic propulsion systems can be advantageously incorporated into enclosures described herein, which may, along with acoustic mitigation, direct noise up and aft of the propulsion system in order to reduce acoustic signature on the ground. Additionally, positioning the high-pressure gas source (e.g. turbine and compressor) within the core of the enclosure provides the ability to tailor airflows and materials and also to isolate vibration emitters in order to reduce propagated sound and heat energy. Isolating and shock mounting the high-pressure gas source within the enclosure also greatly reduces the probability of damage upon landing, which may be more violent in systems such as JPADS. However, the design of enclosures as described herein is a departure from proposed commercial/private aviation techniques using fluidic propulsion, which typically separate the high-pressure gas source from the thruster, and dispose the thruster in a manner that (1) is directed over an airfoil, and (2) is essentially exposed to the ambient air.

In addition to the example shown in FIG. 7, the fluidic propulsion system with enclosure may be advantageously used to power other specialized low-speed aircraft, including, for example, a human-piloted ground vehicle with parafoil flight capability, as described in U.S. Pat. No. 9,682,620, entitled “AIR-GROUND VEHICLE WITH INTEGRATED FUEL TANK FRAME.” The advantages of sound and/or energy dampening on such vehicles are significant, considering the specialized tasks that they perform. For example, law enforcement and military services that may use such vehicles for clandestine surveillance or insertion are particularly conscious of noise and/or heat signatures that might alert criminals or enemies, thereby compromising operations or otherwise putting personnel at extreme risk. Aspects of the foregoing advantages have been demonstrated via prototype testing, as discussed below.

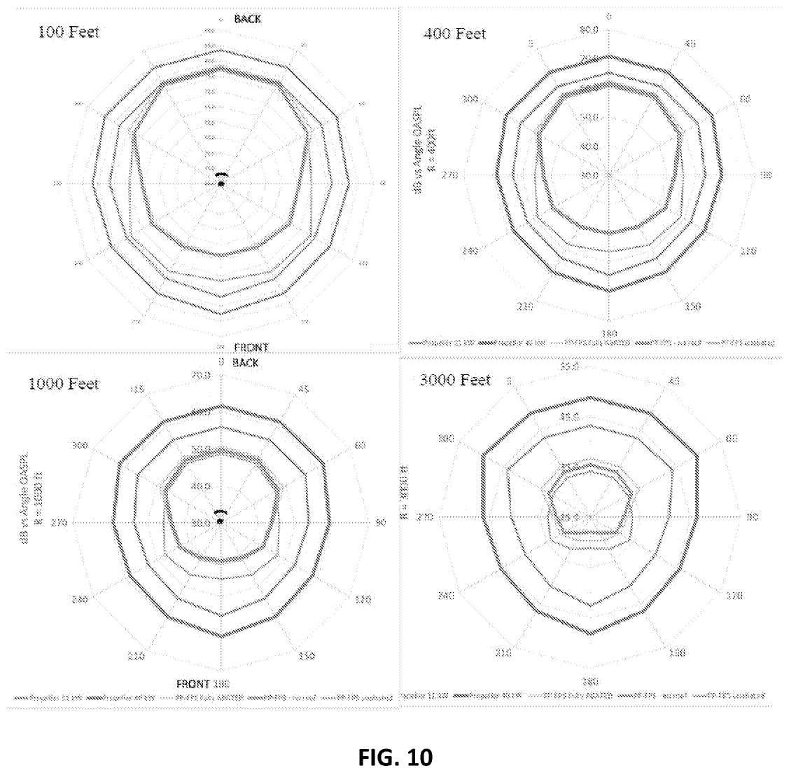

FIG. 8 depicts comparative acoustic signature test results obtained, in part, from prototype fluidic propulsion systems and enclosures according to aspects of the disclosure.

As shown in FIG. 8, the decibels at various frequencies were measured in front of propulsion systems (along with other tests not included herein). The specific systems tested and compared included:
1) Unenclosed fluidic propulsion system (FPS), Dark Blue
2) FPS w/full acoustic mitigation enclosure (AME), Yellow
3) FPS w/AME (upper surface removed), Green
4) FPS w/AME (upper surface and baffles removed), Light Blue
5) Propeller 40 KW, Red

As can be seen in the graph provided in FIG. 8, the propeller curve (red) is significantly higher in the low frequencies that carry longer distances, and the unabated fluidic propulsion system (dark blue) ‘crosses over’ near 4000 Hz, but the mitigated configurations (yellow, green and light blue) all remained significantly lower across the frequency spectrum, with the acoustic mitigation enclosure demonstrating effectiveness across all of the relevant frequency ranges.

In addition to acoustic measurements, thrust was also measured to establish a baseline correlation between different acoustic mitigation enclosure configurations and system efficiency. Such testing (along with other test results from different angles) also demonstrates the potential to tailor specific configurations of the acoustic mitigation enclosure to obtain specific results, e.g. in certain frequency ranges, directions, and/or thrust efficiencies.

While various embodiments have been described above, it is to be understood that the examples and embodiments described above are for illustrative purposes only and that various modifications or changes in light thereof will be suggested to persons skilled in the art, and are to be included within the spirit and purview of this application and scope of the appended claims. Therefore, the above description should not be understood as limiting the scope of the invention as defined by the claims.

What is claimed is:

1. A fluidic propulsion system enclosure, comprising:
a high-pressure gas source container;
a high-pressure gas source inlet;
an ambient air inlet;
a thruster container;
a thruster outlet in fluid communication with the high-pressure gas source inlet and the ambient air inlet; and/or
a housing substantially surrounding and interconnecting the high-pressure gas source container and the thruster container.

2. The fluidic propulsion system enclosure of claim 1, further comprising a plurality of sound abatement baffles.

3. The fluidic propulsion system enclosure of claim 2, wherein the plurality of sound abatement baffles are disposed between the high-pressure gas source container and the thruster container.

4. The fluidic propulsion system enclosure of claim 3, wherein the sound abatement baffles include a sound dampening material.

5. The fluidic propulsion system enclosure of claim 1, wherein the housing includes a sound dampening material.

6. The fluidic propulsion system enclosure of claim 1, further comprising a high-pressure gas source.

7. The fluidic propulsion system enclosure of claim 6, wherein the high-pressure gas source is at least one of a gas turbine, a turbo fan, or a compressor.

8. The fluidic propulsion system enclosure of claim 6, wherein the high-pressure gas source is entirely contained in the housing.

9. The fluidic propulsion system enclosure of claim 6, further comprising a thruster in fluid communication with the high-pressure gas source and the ambient air inlet.

10. The fluidic propulsion system enclosure of claim 9, wherein the thruster is entirely contained in the housing.

11. The fluidic propulsion system enclosure of claim 1, further comprising a fuel inlet.

12. The fluidic propulsion system enclosure of claim 1, further comprising a fuel tank in fluid communication with the fuel inlet.

13. The fluidic propulsion system enclosure of claim 1, wherein the top of the housing is open to the ambient air.
